(19) United States
(12) Patent Application Publication
(10) Pub. No.: US 2026/0314699 A1
(43) Pub. Date: Oct. 15, 2026

(54) CONSUMABLE CLASSIFICATION BASED ON TRANSPARENCY OF PLUG ELEMENT

(71) Applicant: Philip Morris Products S.A., Neuchatel (CH)

(72) Inventors: Jérôme Christian COURBAT, Cortaillod (CH); Laurent Serge LAVANANT, Evian-les-Bains (FR); Emmanuel Gérard René ROUGET, Fontaines (CH); Julien VIDAL, Peseux (CH)

(73) Assignee: Philip Morris Products S.A., Neuchatel (CH)

(21) Appl. No.: 19/482,164

(22) PCT Filed: May 8, 2024
(86) PCT No.: PCT/EP2024/062801

§ 371 Date: Nov. 6, 2025

(30) Foreign Application Priority Data
May 12, 2023 (EP) 23173068.0

(51) Int. Cl. A24F 40/53; A24D 1/02; A24D 1/20; A24F 40/20; A24F 40/51; A24F 40/57; H05B 1/02

(52) U.S. Cl. CPC A24F 40/53; A24D 1/02; A24D 1/20; A24F 40/20; A24F 40/51; A24F 40/57; H05B 1/0252

(57) ABSTRACT

An aerosol-generating device is provided, including: a cavity configured to receive an aerosol-generating article including aerosol-forming substrate, and an optical detector configured to detect a transparency of a portion of the aerosol-generating article. An aerosol-generating article is also provided, including: an aerosol-forming substrate in an aerosol-forming substrate portion; and a substrate wrapper at least partly circumscribing the aerosol-forming substrate portion, a portion of the aerosol-generating article having a predefined transparency. An aerosol-generating system including the aerosol-generating device and an aerosol-generating article is also provided. A method for identifying an aerosol-generating article in an aerosol-generating device of an aerosol-generating system is also provided.

The present invention relates to an aerosol-generating device, an aerosol-generating article, an aerosol-generating system and a method for identifying an aerosol-generating article.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device. Aerosol-generating devices are typically designed to operate best when used with an original and specifically designed aerosol-generating article. Furthermore, manufacturers of aerosol-generating articles may offer a product line of an aerosol-generating article in a variety of types with different characteristics, such as flavor or nicotine content.

It would be desirable to provide an aerosol-generating device capable of identifying an aerosol-generating article. It would be desirable to provide an aerosol-generating device capable of detecting an authorized aerosol-generating article. It would be desirable to provide an aerosol-generating device capable of detecting an aerosol-generating article with enhanced reliability. It would be desirable to provide an aerosol-generating device with improved detection capabilities. It would be desirable to have an aerosol-generating device providing an optimized user experience. It would be desirable to have an aerosol-generating article enabling improved identification by an aerosol-generating device.

According to a first aspect of the invention there is provided an aerosol-generating device comprising a cavity and/or an optical detector. The cavity may be configured for receiving an aerosol-generating article, optionally comprising an aerosol-forming substrate. The optical detector may be configured for detecting a transparency of a portion, optionally a distal portion, of the aerosol-generating article.

According to another aspect, there is provided an aerosol-generating device comprising, a cavity for receiving an aerosol-generating article comprising aerosol-forming substrate, and an optical detector configured to detect the transparency of a portion of the aerosol-generating article.

An aerosol-generating article may comprise a plurality of elements, including one or more of a mouthpiece, a spacer, a hollow acetate tube, a plug of aerosol-generating substrate and a front plug. All elements may be connected to each other by an outer wrapper. An aerosol-generating article may have a cylindrical shape.

The front plug may be used as an end portion of the aerosol-generating article. The front plug may be used to ensure that the plug of aerosol-generating substrate is retained within the aerosol-generating article. The front plug may be made from a material that allows air to be drawn through the front plug. The front plug may be made from a material having an adequate porosity. The front plug may be made from a filter material. The front plug may be made from cellulose acetate tow. The front plug may be made from one or more materials selected from the group comprising ceramic, polymer, biopolymer, metal, zeolite, paper, cardboard, inert material, and inorganic material.

The optical detector may be configured for detecting a transparency of any element of a portion, optionally a distal portion, of the aerosol-generating article.

The optical detector may be configured for detecting a transparency of a front plug of an aerosol-generating article. For the sake of simplicity, in the following we will mainly refer only to the front plug, when the transparency detection is described. However, it is to be understood that to achieve the objective of the invention, the transparency of any element of an inserted aerosol-generating article may be detected.

Configuring the optical detector for detecting a transparency of a front plug of an aerosol-generating article may be advantageous. The front plug of an aerosol-generating article may be located at the upstream end of an aerosol-generating article. The front plug is usually located upstream from the aerosol-forming substrate. Accordingly, the front plug may not come into contact with the aerosol generated in the device. Accordingly, transparency of the front plug may not change or may only slightly change during use of the aerosol-generating device. In addition, the optical components of the optical detector may also better be protected from contact with the aerosol, if the optical detector is located upstream from the heating chamber in the cavity of the aerosol-generating device.

The optical detector may have any suitable configuration known to the skilled person.

The optical detector may comprise a light-emitting unit and a light-detecting unit. The light-emitting unit and the light-detecting unit may be arranged at a distal end of the cavity of the aerosol-generating device. The light-emitting unit and the light-detecting unit may be located in the cavity at a position that corresponds to the location of the transparent element, when the aerosol-generating article is inserted into the cavity of the aerosol-generating device.

The light-emitting unit may be arranged at the cavity wall of the aerosol-generating device. The light-emitting unit may be arranged such that the light is emitted into the cavity. The light-emitting unit may be arranged such that the light is emitted into the front plug of the inserted aerosol-generating article.

The light-detecting unit may be arranged at the cavity wall of the aerosol-generating device. The light-detecting unit may be arranged such that light from the cavity is detected. The light-detecting unit may be arranged such that the light transmitted through the front plug of the inserted aerosol-generating article is detected.

The light-emitting unit and the light-detecting unit may be arranged such that light emitted from the light-emitting unit passes through a portion, optionally a distal portion, of an aerosol-generating article received in the cavity and such that the transmitted light is detected by the light-detecting unit. The light-emitting unit and the light-detecting unit may be arranged on opposite sides of the cavity and face each other in a straight direction within a horizontal plane perpendicular to the longitudinal axis of the cavity of the aerosol-generating device.

Preferable light sources have a narrow beam angle. Preferable light sources have a low power consumption.

The light-emitting unit may be a laser diode or a micro laser diode. The light-emitting unit may be a semiconductor-based micron-sized light emitting diode, based on III-V compounds (i.e., alloys containing elements from group III and V in the periodic table), or II-VI compounds (i.e., alloys containing elements from group II and VI in the periodic table). The light emitting diode may be based on gallium nitride (GaN), indium gallium nitride (InGaN), gallium arsenide (GaAs), or aluminum gallium indium phosphide (AlGaInP). The light-emitting unit may be a vertical cavity surface emitting laser (VCSEL). Preferable light sources have a narrow beam angle. Preferable light sources have a low power consumption, e.g., light emitting diodes.

The light-emitting unit may be an organic light emitting diode (OLED).

The light-emitting unit may be configured to emit collimated or non-collimated light. The light-emitting unit may be configured to emit collimated or non-collimated light, monochromatic light with a pre-defined wavelength.

The light-emitting unit may be configured to emit visible, UV-or IR-light. The light-emitting unit may be configured to emit monochromatic light with a pre-defined wavelength in the visible, UV-or IR-range.

The light emitting unit may be configured to emit light in the visible spectrum (around 400 nanometres to around 700 nanometres). The light emitting unit may be configured to emit light in the invisible spectrum such as in the ultraviolet light spectrum (around 10 nanometres to around 400 nanometres) or the infrared light spectrum (around 700 nanometres to around 1 millimetre).

The light-emitting unit may be configured to emit light with a pre-defined wavelength in the range from about 200 nanometers to about 2 micrometers. The light-emitting unit may be configured to emit light with a pre-defined wavelength in the range from about 400 nanometers to about 1 micrometer. The light-emitting unit may be configured to emit light with a pre-defined wavelength of about 520 nanometers or of about 850 nanometers.

The aerosol-generating device may comprise a plurality of light-emitting units. The light-emitting units may each be configured as described above. The light-emitting units may each be configured to emit light beams with the same wavelength. The light-emitting units may be configured to emit a light beam with a different wavelength.

The light-detecting unit may have any suitable configuration known to the skilled person. Preferable light-detecting units have a high sensitivity. Preferable light-detecting units have a low power consumption.

The light-detecting unit may be chosen to be suitable to be used with the light-emitting units used in the aerosol-generating device. In particular, the sensitivity and the operational range may be chosen to correspond to the light-emitting units used in the aerosol-generating device.

The light-detecting unit may be a semiconductor-based photodetector, a phototransistor, or a photodiode, such as a PIN photodiode. The light-detecting unit may be an infrared detector. The light-detecting unit may be an infrared detector based on mercury cadmium telluride (HgCdTe). The light-detecting unit may be a radiation detector based on cadmium zinc telluride (CdZnTe).

The light-detecting unit may be a flat-field detector. The light-detecting unit may be a photodetector with a flat receiving interface.

The light-detecting unit may be a spherical shaped detector. A spherical shaped detector may be configured to collect incoming radiation from different incident angles.

The aerosol-generating device may comprise a plurality of light-detecting units. The light-detecting units may each be configured as described above. The light-detecting units may each have an identical configuration. The light-detecting units may be configured to be sensitive to different wavelength ranges.

The optical detector may comprise a plurality of light-emitting units and a plurality of light-detecting units. The light-emitting units and the light-detecting units may be arranged pairwise. The light-emitting units and the light-detecting units may be arranged such that each one of the light-emitting units cooperates with one of the light-detecting units. Each light-detecting unit may be placed to face the corresponding light-emitting unit in a straight direction on a horizontal plane perpendicular to the longitudinal axis of the aerosol-generating device. Each light-detecting unit may be configured to be light-sensitive enough to detect a difference in the spectrum of the emitted light beams from each of the corresponding light-emitting units.

The optical detector may comprise a plurality of light-emitting units and a single light-detecting unit. In this case, the light-detecting unit is preferably configured to be able to collect incoming radiation from different incident angles and/or different wavelengths corresponding to those emitted by the light emitting unit. In particular, the light-detecting unit may be a spherical shaped detector. The light-detecting unit may be configured to be light-sensitive enough to detect a difference in the spectrum of the emitted light beams from each of the light-emitting units.

The optical detector may be configured to provide an electrical signal depending on the transparency of a portion, optionally a distal portion, of an inserted aerosol-generating article. To be more specific, when an aerosol-generating article is inserted into the cavity of the aerosol-generating device, the light-emitting unit may be activated. The light-emitting unit may emit a light beam towards the portion of the aerosol-generating article. A part of the light beam will be reflected, scattered, and/or absorbed by the portion of the aerosol-generating article. The remaining portion of the light beam may be transmitted through the portion of the aerosol-generating article. The transmitted portion of the light beam may be detected by the light-detecting unit. The light-detecting unit may generate a detector output or an electrical signal that corresponds to the measured portion of the transmitted light beam. This electrical signal may then be sent to a controller of the aerosol-generating device. The electrical signal may depend on the amount of light transmitted through the portion of the aerosol-generating article. The optical detector is thus configured to detect the transmittance or the transparency of the portion of the aerosol-generating article. The aerosol-generating device may comprise a controller. The optical detector may be electrically coupled to the controller. The optical detector may be configured to transmit the electric signal corresponding to the transparency of the front plug to the controller.

The controller may be configured to analyze the electric signal provided by the optical detector. The controller may determine the transparency of the front plug based on an analysis of the electric signal provided by the optical detector. The transparency of the front plug of the aerosol-generating article may be indicative of the type of the inserted aerosol-generating article.

The controller may comprise a memory. The memory may comprise pre-stored reference data. The reference data may comprise reference signals of the optical detector. Each of such reference signals may correspond to a front plug having a specified transparency.

The controller may be configured to compare the electrical signal provided form the optical detector with the pre-stored reference data. The controller may be configured to correlate the electrical signal provided form the optical detector with the pre-stored reference data. The controller may be configured to detect and identify the type of the inserted aerosol-generating article by correlating the electrical signal provided form the optical detector with the pre-stored reference data. In this way the controller may be configured to identify the aerosol-generating article inserted into the cavity of the aerosol-generating device.

It will be appreciated that identifying the aerosol-generating article for use with the aerosol-generating device may be useful for a variety of different purposes, and the invention is not limited to any one particular purpose for identifying the aerosol-generating article. For instance, identifying the aerosol-generating article may allow one of a plurality of predetermined heating profiles to be applied that is associated with the identified aerosol-generating article; identifying the aerosol-generating article may allow a user interface of the aerosol-generating device to operate differently in response to identifying the aerosol-generating article, e.g. by displaying a flavour of the aerosol-generating article; and/or identifying the aerosol-generating article may allow a record of consumption of each type of aerosol-generating article used with the aerosol-generating device to be stored at the aerosol-generating device to assist the user in monitoring their usage habits.

The invention may provide means and a method to detect and identify authorized aerosol-generating articles and specific types of aerosol-generating articles received in the aerosol-generating device. The device may be provided with a controller monitoring and processing the signal output of the optical detector. By comparing the signal output of the optical detector with pre-stored reference data, the controller may one or more of: (i) determine the presence of an authorized article in the device, (ii) identify the type of the inserted article, (iii) regulate operation of the device in dependence on the characteristics of the inserted aerosol-generating article, and (iv) determine the presence and/or absence of an article in the device.

Authorized articles may be provided with a portion, optionally a distal portion, having a specific transparency. Authorized articles may be provided with a front plug having a specific transparency. In response to the detection of the authorized article, the controller may enable one or both of operation of the device and provision of a user experience. For example, power may be provided to a heating assembly of the aerosol-generating device. If the device does not detect an authorized article, the device may one or both of prevent operation of the device and provision of a user experience. For example, power being provided to the heating assembly may be prevented.

The invention may allow the provision of an optimized user experience by adapting aerosol generation to the type of article inserted in the device. Articles belonging to a type of article may be provided with a type specific front plug having a specific transparency. By comparing the output signal generated by the optical detector with pre-stored reference data, the device may identify the article type inserted in the device. In response, the device may adapt and thereby optimize aerosol generation. For example, a pre-stored type specific heating profile may be employed. The type specific heating profile may correspond to a type specific configuration of aerosol-forming substrate within the article.

In use, the article comprising a front plug with specific transparency may be inserted into the cavity of the device by a user. After insertion, the article in particular the transparent front plug is located at the optical detector. The optical detection of the transparency may be carried out, and the output signal of the optical detector may be provided to the controller. The controller may correlate the provided optical detector output to pre-stored reference data to identify the inserted article. In response, the controller may adjust the operation of the device.

The invention may provide article detection and identification with one or more of an improved reliability and improved consistency. By reducing the risk of erroneous rejection of authorized articles, consumer satisfaction may be enhanced.

The invention may provide article detection and identification that does not require the use of extra markings of the articles. This may reduce manufacturing cost.

In particular, it is sufficient to provide the aerosol-generating articles with a front plug having the desired transparency, such that it can be identified by the controller of the aerosol-generating device. Additional marking or modification of the articles is not required.

Detection of the presence of an authorized aerosol-generating article in the device may prevent or at least reduce the risk of usage of counterfeit and non-authorized articles with the device. Damage to the device may be avoided. Economic losses of authorized article manufacturers may be minimized.

Identification of a specific type of aerosol-generating article in the device may enable the provision of an optimized user experience. For example, an article type specific heating profile may be provided. Aerosol generation may be optimized and adapted according to the article type inserted in the device.

Identification of an aerosol-generating article using transparency detection may offer versatile use of different types of heating elements.

A longitudinal axis of a component may be an axis along or parallel to the lengthwise direction of the component. A longitudinal axis of the device may extend between the distal end and the proximal end of the device. A longitudinal axis of the article may extend between the distal end and the proximal end of the article.

The device may comprise a heating element, preferably a heating coil.

The heating element may be arranged at least partly, preferably fully, surrounding the cavity. The heating element may be arranged at a distal end of the cavity.

The device may comprise a controller. The controller may be configured for identifying a type of the aerosol-generating article based on an output of the optical detector. The output of the optical detector may be an electrical signal.

The controller may comprise a microprocessor, which may be a programmable microprocessor. The controller may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The controller may be configured to monitor the electrical resistance of the heating element, and preferably to control the supply of power to the heating element dependent on the electrical resistance of the heating element.

The controller may be configured to monitor the output of the optical detector. The controller may be configured to record the output of the optical detector. The controller may be configured to process the output of the optical detector. The controller may be configured to analyse the output of the optical detector. The controller may be configured to identify the aerosol-generating article by processing the output of the optical detector. The controller may be connected to the optical detector. The controller may be configured to communicate with the optical detector. The controller may be configured to determine the presence and/or absence of an aerosol-generating article by processing the output of the optical detector. The controller may be configured to permit aerosol to be generated only after determining that an aerosol-generating article is present. The controller may be configured to prohibit aerosol generation, or cease aerosol generating, in response to determining that an aerosol-generating article is absent.

The controller may be configured to regulate power supply to the heating element based on the identification of a type of aerosol-generating article. Upon identification of a type of aerosol-generating article, the controller may allow power to be supplied to the heating element. Upon identification of a type of aerosol-generating article, the controller may allow the provision of a user experience. Upon identification of a type of aerosol-generating article, the controller may adjust the power supply in dependence on the article type identified. The controller may be configured to provide power to the heating element according to a predefined heating profile for the respective identified article.

The controller may adjust the magnitude of power supply in dependence on the article type identified. The controller may adjust the time period of power supply in dependence on the article type identified. The controller may adjust the temperature of the heating element in dependence on the article type identified. The controller may adjust one or more of the amplitude and the frequency of a current supplied to the heating element in dependence on the article type identified. The controller may adjust the signal powering the heating element in dependence on the article type identified.

The memory of the controller may comprise a database of pre-stored heating profiles for each known type of aerosol-generating article. The controller may be configured to provide power according to the heating profile of the identified type of aerosol-generating article. Power supply may be tailored to the configuration of a specific article type. Aerosol-generation and the user experience may be optimized.

The heating element may comprise a heating coil. The heating coil may have a length of between 15 millimeters and 31 millimeters, preferably of between 11 millimeters and 21 millimeters.

In a second aspect, the invention relates to an aerosol-generating article comprising an aerosol-forming substrate in an aerosol-forming substrate portion; and a substrate wrapper at least partly circumscribing the aerosol-forming substrate portion. A portion, optionally a distal portion, of the aerosol-generating article is formed such as to have a predefined transparency.

A “distal portion” of the aerosol-generating article refers to the portion of the aerosol-generating article that in use may be inserted into the cavity of an aerosol-generating device. The portion of the aerosol-generating article that is not inserted into the cavity of the aerosol-generating device is referred to herein as a “proximal portion” of the of an aerosol-generating article.

An aerosol-generating article may comprise a plurality of elements, including one or more of a mouthpiece, a spacer, a hollow acetate tube, a plug of aerosol-generating substrate and a front plug. All elements may be connected to each other by an outer wrapper.

An aerosol-generating article may have any cross-sectional shape. An aerosol-generating article may have a cylindrical shape.

The portion, optionally the distal portion, of the aerosol-generating article may be formed to comprise the front plug. The front plug may be used as an end portion of the aerosol-generating article. The front plug may be used to ensure that the plug of aerosol-generating substrate is retained within the aerosol-generating article during use.

The front plug may be transparent or semi-transparent and may have a predefined transparency. The front plug may be made from a material that allows air to be drawn through the front plug. The front plug may be made from a material having an adequate porosity. The front plug may be made from a filter material.

The front plug may comprise cellulose acetate tow formed from a transparent or semi-transparent continuous crimped band of cellulose acetate fibers and may have a predefined transparency.

The front plug may comprise one or more materials selected from the group comprising ceramic, polymer, biopolymer, metal, zeolite, paper, cardboard, inert material, and inorganic material.

The front plug may comprise a transparent wrapper. The front plug may comprise a transparent paper wrapper. The transparent wrapper may be made from an acetate ester of cellulose. The transparent wrapper may be made from an acetate ester of cellulose selected from the group of cellulose acetate, cellulose diacetate, and cellulose triacetate.

The outer wrapper may be an outer paper wrapper. The outer wrapper may be a transparent outer paper wrapper. A transparent outer paper wrapper may comprise acetate ester of cellulose.

The outer wrapper may be made from an annual plant pulp, such as a linen, hemp or sisal pulp. The outer wrapper may be made from a chemical pulp. The outer wrapper may be made from a mixture of natural and chemical pulps.

The outer wrapper may be a transparent wrapper.

The outer wrapper may be an opaque outer wrapper. An opaque outer wrapper may comprise a cut-out. The cut-out section may be placed around the front plug. The cut-out section may be placed around the front plug and along the longitudinal axis of the aerosol-generating article. The cut-out section may be placed around the front plug so as to optically expose the front plug through the cut-out section in the outer wrapper.

By providing the outer wrapper as transparent wrapper or by providing a cut-out in the outer wrapper, an optical detection of the transparency of the front plug is facilitated.

The transparency of the transparent front plug, of the transparent wrapper and of any other transparent or semi-transparent element comprised in the aerosol-generating article may be defined according to ASTM D1003-13.

The transparency of the front plug may be above 5, 10, 15, 20, 25, or 30 percent. The transparency of the front plug may be above 50 percent. The transparency of the front plug may be above 70 percent. The transparency may be any non-zero transparency value.

The transparency of the front plug may also be defined by its total transmittance. The total transmittance of the front plug may be less than 95 percent, less than 95 percent, 90 percent, 85 percent, 80 percent, 75 percent, 70 percent, 65 percent, 60 percent, 55 percent, 50 percent, 45 percent, 40 percent, 35 percent, 30 percent, 25 percent, 20 percent, 15 percent, 10 percent, and less than 5 percent.

According to a third aspect, the invention relates to an aerosol-generating system comprising an aerosol-generating device as described herein and an aerosol-generating article.

The aerosol-generating article may be configured as described above.

The aerosol-generating device may be configured to be used with a plurality of different types of aerosol-generating articles.

In a fourth aspect, the invention relates to a method for identifying an aerosol-generating article in an aerosol-generating device of an aerosol-generating system, such as an aerosol-generating device of an aerosol-generating system as described herein. The method comprises detecting, by an optical detector, the transparency of a portion, optionally a distal portion, of the aerosol-generating article.

The method may be used with an aerosol-generating system comprising an aerosol-generating article with a front plug having a predefined transparency. The method may further comprise the steps of identifying the aerosol-generating article by determining the transparency of the front plug of the article.

The method may comprise the steps of identifying the aerosol-generating article by detecting, with an optical detector, a transparency of a portion, optionally a distal portion, of an aerosol-generating article and by comparing the detector output with reference data.

The method may further comprise the step of controlling operation of the aerosol-generating device depending upon an optical detector output.

The step of controlling the operation of the aerosol-generating device may include preventing operation of the aerosol-generating device if an unauthorized aerosol-generating article is detected.

The step of controlling the operation of the aerosol-generating device may include choosing a heating profile of the aerosol-generating device depending upon an output of the optical detector.

As used herein, the term “transparency” refers the ability of an object to allow light to pass through the object. The term “light” refers to both the visible spectrum (around 400 nanometres to around 700 nanometres) and the invisible spectrum including the ultraviolet light spectrum (around 10 nanometres to around 400 nanometres) and the infrared light spectrum (around 700 nanometres to around 1 millimetre). As is known, an object's “transparency” is measured by its measured “transmittance”. Thus, the terms “transparency” and “transmittance” are used interchangeably herein. An object's “transmittance” is measured as the ratio of the light transmitted through the object to the light incident on the object, i.e., transmittance =transmitted light/incident light.

As used herein, the term “transparent” when used in connection with an object refers to an object through which light can be transmitted at least partially. Thus, the term “transparent” refers to transparent, semi-transparent, or translucent objects, e.g., a non-opaque object.

As used herein, the terms ‘proximal’, ‘distal’, ‘downstream’ and ‘upstream’ are used to describe the relative positions of components, or portions of components, of the aerosol-generating device and the aerosol-generating article in relation to the direction in which a user draws on the aerosol-generating device or aerosol-generating article during use thereof.

The aerosol-generating system may comprise a mouth end through which in use an aerosol exits the aerosol-generating system and is delivered to a user. The mouth end may also be referred to as the proximal end. In use, a user draws on the proximal or mouth end of the aerosol-generating system in order to inhale an aerosol generated by the aerosol-generating system. The aerosol-generating system comprises a distal end opposed to the proximal or mouth end. The proximal or mouth end of the aerosol-generating system may also be referred to as the downstream end and the distal end of the aerosol-generating system may also be referred to as the upstream end. Components, or portions of components, of the aerosol-generating system may be described as being upstream or downstream of one another based on their relative positions between the proximal, downstream or mouth end and the distal or upstream end of the system.

The aerosol-generating device may comprise a mouth end through which in use an aerosol exits the aerosol-generating device and is delivered to a user. In use, a user draws on the proximal or mouth end of the aerosol-generating device in order to inhale an aerosol generated by the aerosol-generating device. Alternatively, a user may directly draw on an aerosol-generating article inserted into an opening at the proximal end of the aerosol-generating device. The opening at the proximal end may be an opening of the cavity. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may have a length of between 86 millimeters to 130 millimeters.

The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece. The cavity may have a length of between 28 millimeters and 67 millimeters. The cavity may have a diameter of between 8 millimeters and 12 millimeters.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

As described, in any of the aspects of the disclosure, the heating element may be part of an aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

As an alternative to an electrically resistive heating element, the heating element may be configured as an induction heating element. The induction heating element may comprise an induction coil and a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. The susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped.

The aerosol-generating article may have a total length between 55 millimeters and 110 millimeters, preferably of between 60 millimeters and 90 millimeters. The aerosol-generating article may have an external diameter between 4.5 millimeters and 17 millimeters, preferably between 6 millimeters and 9 millimeters. The aerosol-generating article may comprise a filter plug. The filter plug may be located at a downstream end of the aerosol-generating article. The filter plug may be a cellulose acetate filter plug. The filter plug is approximately 7 millimeters in length in one embodiment, but may have a length of between approximately 5 millimeters to approximately 10 millimeters.

The aerosol-generating article may comprise a separation between the aerosol-forming substrate and the filter plug. The separation may be approximately 18 millimeters, but may be in the range of 5 millimeters to 25 millimeters.

Below, there is provided a non-exhaustive list of non-limiting examples. Any one or more of the features of these examples may be combined with any one or more features of another example, embodiment, or aspect described herein.

Example Ex1. An aerosol-generating device comprising, a cavity for receiving an aerosol-generating article comprising aerosol-forming substrate, and an optical detector configured to detect the transparency of a portion, optionally a distal portion, of the aerosol-generating article.

Example Ex2. An aerosol-generating device according to the preceding example, wherein the optical detector comprises a light-emitting unit and a light-detecting unit.

Example Ex3. An aerosol-generating device according to any of the preceding examples, wherein the light-emitting unit and the light-detecting unit are arranged in the cavity, preferably at a distal end of the cavity.

Example Ex4. An aerosol-generating device according to any of the preceding examples, wherein the light-emitting unit and the light-detecting unit are arranged on opposite sides of the cavity and face each other in a straight direction within a horizontal plane perpendicular to the longitudinal axis of the cavity of the aerosol-generating device.

Example Ex5. An aerosol-generating device according to any of the preceding examples, wherein the light-emitting unit and the light-detecting unit are arranged such that light emitted from the light-emitting unit passes through a portion, optionally a distal portion, of an aerosol-generating article received in the cavity and the transmitted light is detected by the light-detecting unit.

Example Ex6. An aerosol-generating device according to any of the preceding examples, wherein the light-emitting unit is configured to emit collimated or non-collimated, monochromatic light with a pre-defined wavelength.

Example Ex7. An aerosol-generating device according to any of the preceding examples, wherein the pre-defined wavelength is visible, UV or IR light, and ranges from about 400 nanometers to 1 millimeter.

Example Ex8. An aerosol-generating device according to any of the preceding examples, wherein the light-detecting unit is a flat-field detector, such as a photodetector with a flat receiving interface, or wherein the light-detecting unit is a spherical shaped detector, configured to collect incoming radiation from different incident angles.

Example Ex9. An aerosol-generating device according to any of the preceding examples, wherein the aerosol-generating device comprises a plurality of light-emitting units and/or light-detecting units.

Example Ex10. An aerosol-generating device according to any of the preceding examples, wherein the light-emitting unit is a laser diode, a micro laser diode, a semiconductor-based micron-sized light emitting diode, based on gallium nitride (GaN), indium gallium nitride (InGaN) or aluminium gallium indium phosphide (AlGaInP), or a vertical cavity surface emitting laser (VCSEL).

Example Ex11. An aerosol-generating device according to any of the preceding examples, wherein the light-detecting unit is a semiconductor-based photodetector, such as an infrared detector based on mercury cadmium telluride (HgCdTe) or a radiation detector based on cadmium zinc telluride (CdZnTe), a phototransistor, or a photodiode, such as a PIN photodiode.

Example Ex12. An aerosol-generating device according to any of the preceding examples, the aerosol-generating device further comprising a controller electrically coupled to the optical detector, wherein the controller is configured to analyze the electric signal provided by the optical controller and to thereby identify the aerosol-generating article.

Example Ex13. An aerosol-generating device according to any of the preceding examples, wherein identification of the aerosol-generating article is done by comparing the measured data to pre-stored reference data.

Example Ex14. An aerosol-generating device according to any of the preceding examples, wherein the portion, optionally the distal portion, of the aerosol-generating article comprises a front plug, and wherein the optical detector is configured to detect a transparency of the front plug of the aerosol-generating article.

Example Ex15. An aerosol-generating article, comprising an aerosol-forming substrate in an aerosol-forming substrate portion; and a substrate wrapper at least partly circumscribing the aerosol-forming substrate portion, wherein a portion, optionally a distal portion, of the aerosol-generating article is formed such as to have a pre-defined transparency.

Example Ex 16. The aerosol-generating article according to example 15, wherein the portion of the aerosol-generating article is formed from a front plug, wherein the front plug is transparent or semi-transparent and has a predefined transparency.

Example Ex17. The aerosol-generating article according to the preceding example, wherein the transparency of the front plug is defined according to ASTM D1003-13.

Example Ex18. The aerosol-generating article according to the preceding example, wherein the front plug comprises cellulose acetate tow formed from a transparent or semi-transparent continuous crimped band of cellulose acetate fibers, with a predefined transparency.

Example Ex19. The aerosol-generating article according to the preceding example, wherein the front plug comprises a transparent wrapper and wherein the aerosol-generating article comprises an outer wrapper that circumscribes and connects the front plug to the further components of the aerosol-generating article.

Example Ex20. The aerosol-generating article according to the preceding example, wherein the outer wrapper comprises a cut-out section that is placed around the front plug so as to visually expose the front plug through the cut-out section in the outer wrapper.

Example Ex21. An aerosol-generating system comprising the aerosol-generating device according to any one of examples 1 to 14 and an aerosol-generating article, preferably according to any one of examples 15 to 20.

Example Ex 22. A method for identifying an aerosol-generating article in an aerosol-generating device of an aerosol-generating system, optionally according to example 21, wherein the method comprises detecting, by an optical detector, a transparency of a portion, optionally a distal portion, of the aerosol-generating article.

Example Ex23. The method according to the preceding example, further comprising the steps of identifying the aerosol-generating article by comparing the detected optical transparency to reference data.

Example Ex24. The method according to any of the preceding examples, further comprising the step of controlling operation of the aerosol-generating device depending upon an optical detector output.

Example Ex25. The method according to any of the preceding examples, wherein controlling the operation of the aerosol-generating device includes deactivating operation of the aerosol-generating device if an unauthorized aerosol-generating article is detected.

Example Ex26. The method according to any of the preceding examples, wherein controlling the operation of the aerosol-generating device includes choosing a heating profile of the aerosol-generating device depending upon an optical detector output.

Features described in relation to one embodiment may equally be applied to other embodiments of the invention.

The invention will be further described, by way of example only, with reference to the accompanying drawings in which:

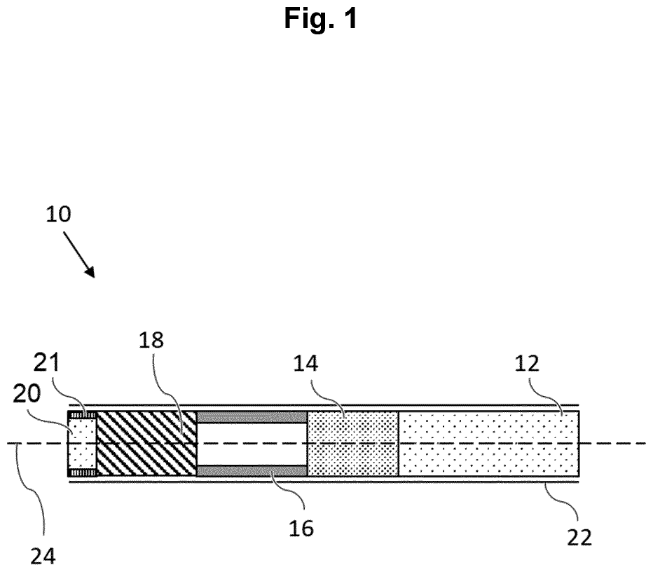

FIG. 1 shows a cross-sectional view of an aerosol-generating article;

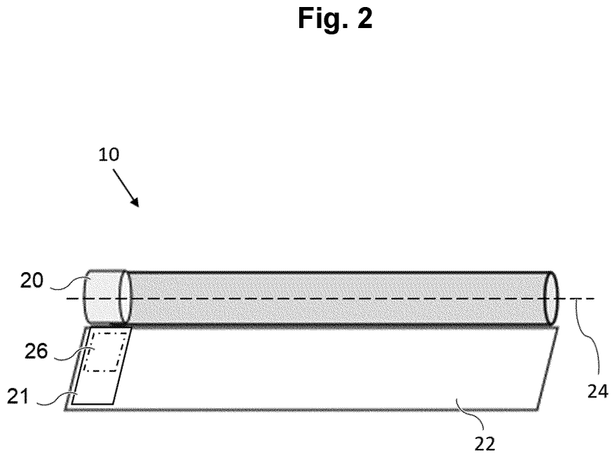

FIG. 2 shows an aerosol-generating article with a transparent front plug;

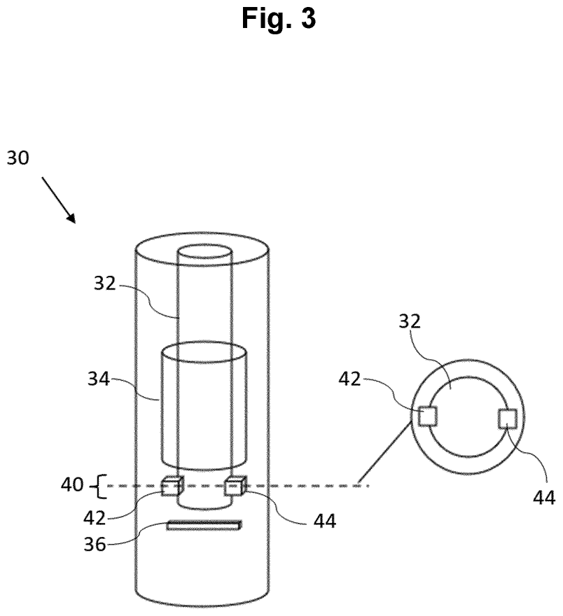

FIG. 3 shows an aerosol-generating device with an optical detector;

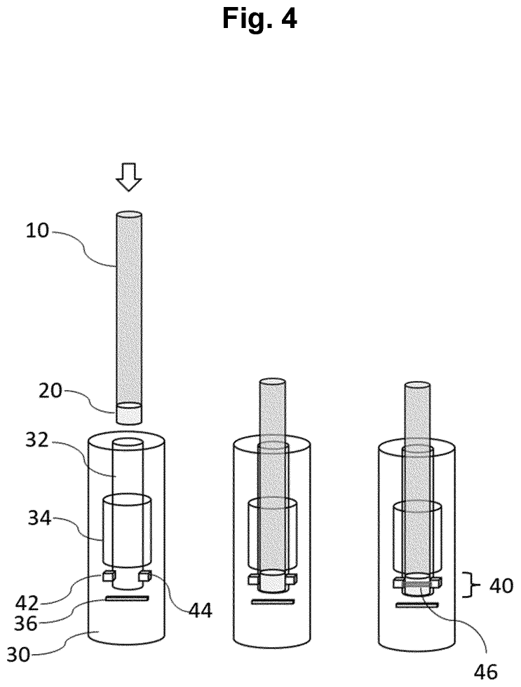

FIG. 4 shows an optical detection in an aerosol-generating device; and

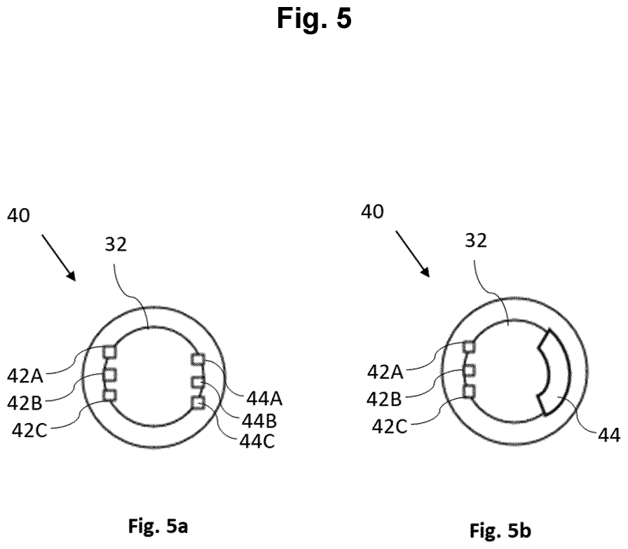

FIG. 5 shows various configurations of an optical detector.

FIG. 1 shows an aerosol-generating article 10 in a cross-sectional view. The aerosol-generating article 10 comprises a mouth-end filter 12 located at a proximal end of the article 10. The article 10 further comprises a PLA (poly lactic acid) plug 14, a hollow acetate tube 16, and an aerosol-forming substrate portion 18 comprising an aerosol-forming substrate, for example, a gathered sheet of homogenized tobacco. At the distal end of the article 10 there is provided a front plug 20. A center axis 24 extends centrally along a longitudinal direction of the aerosol-generating article 10.

Front plug 20 is formed from cellulose acetate tow, made up of a semi-transparent continuous crimped fiber band that includes cellulose acetate fibers. The front plug is circumscribed by a transparent front plug wrapper 21. The overall transparency of the front plug amounts to 50 percent, or below (but greater than zero percent). The aerosol-generating article 10 is circumscribed by an outer wrapper 22. At the distal end of the outer wrapper 22 there is provided a cut-out section.

The cut-out section 26 is shown in more detail in FIG. 2, which depicts in a simplified view an aerosol-generating article 10 comprising a transparent front plug 20 at the distal end. FIG. 2 shows the transparent front plug 20 that is circumscribed by a transparent front plug wrapper 21. The overall aerosol-generating article 10 is wrapped by outer wrapper 22. At the distal end and coinciding with the position of the transparent front plug 20, the outer wrapper 22 is provided with a cut-out section 26. The cut-out section 26 allows incident light to pass through the front plug 20. In the fully assembled aerosol-generating article 10, the cut-out section 26 is placed around the front plug 20 and along the longitudinal axis 24 of the aerosol-generating article 10. The transparent front plug 22 is thus exposed through the cut-out section 26 in the outer wrapper 22.

For generating an aerosol, the aerosol-generating article 10 is inserted into a cavity 32 of an aerosol-generating device 30. Such aerosol-generating device 30 is schematically depicted in FIG. 3. The aerosol-generating device 30 defines a cavity 30, which is configured for receiving an aerosol-generating article 10. A portion of the cavity 30 is surrounded by a heating element 34. In the embodiment shown in FIG. 3, the heating element 34 is an external, resistive heating element. The controller 36 is configured to supply power from a power supply (not shown) to heat the heating element 34.

At the bottom of the cavity 32 of the aerosol generating device 30 there is provided an optical detector 40. The optical detector 40 comprises a light-emitting unit 42 and a light-detecting unit 44. The light-emitting unit 42 and the light-detecting unit 44 are positioned at opposite sides of the cavity 32 of the aerosol-generating device 30. The light-emitting unit 42 and the light-detecting unit 44 are positioned to enable an optical transparency detection of the front plug 20 of an inserted aerosol-generating article 10.

As shown in the enlarged cross-sectional view on the right-hand side of FIG. 3, the light-emitting unit 42 and the light-detecting unit 44 are placed on opposite sides of the cavity 32 to face each other in a straight direction on a horizontal plane perpendicular to the longitudinal axis of the aerosol-generating device 30.

The optical detector 40 is arranged upstream from the heating element 34. In this way the optical detector 40 and the front plug 20 may largely be prevented from coming into contact with the aerosol generated in the cavity 32 in the area adjacent to the heating element 34. Accordingly, transparency of the front plug 22 may not change or may only slightly change during use of the aerosol-generating device 30. In addition, possible contaminations of the optical components of the optical detector 40 may be reduced in such configuration.

FIG. 4 illustrates details of the operation of an aerosol-generating system comprising an aerosol-generating device 30 and an aerosol-generating article 10. In the beginning, as shown in the left-hand view of FIG. 4, an aerosol-generating article 10 is inserted into the cavity 32 of the aerosol-generating device 30 along the longitudinal axis of the aerosol-generating device. The fully inserted aerosol-generating article 10 is shown in the middle view of FIG. 4. When the aerosol-generating article 10 is fully inserted, the transparent front plug 20 is located between the light-emitting unit 42 and the light-detecting unit 44 of the optical detector 40. After the aerosol-generating article 10 is placed within the cavity 32, the controller 36 activates the light-emitting unit 42 to emit a collimated light beam 46 towards the front plug 20. Some portions of the collimated light beam 46 are reflected, scattered, or absorbed by the front plug 20. A portion of the collimated light beam 46 is transmitted and passes through the front plug 20. The transmitted portion of the collimated light beam 46 arrives at the light-detecting unit 44. The light-detecting unit 44 generates an electric output signal corresponding to the amount of the transmitted portion of the collimated light beam 46. This output signal is sent to the controller 36 of the aerosol-generating device 30. The controller 36 evaluates the output signal of the optical detector 40. Such evaluation comprises a verification as to whether the inserted article 10 is an authentic article. In addition, evaluation may comprise an identification of the type of the inserted aerosol-generating article 10. The controller 36 may further be configured to supply power to the heating element 34 according to a pre-defined heating protocol for the identified type of aerosol generating article 10.

For this purpose, specific types of aerosol-generating articles 10 are manufactured to have a front plug 20 with a specific transparency. The controller 36 is configured to determine the type of the inserted aerosol-generating article 10, by comparing the measured transparency values to a plurality of data sets stored in the controller's 36 memory. The controller 36 further comprises a database of pre-stored heating profiles for each type of aerosol-generating article 10.

When the user initiates aerosol generation, the controller 36 is configured to provide power to the heating element 34 according to the specific heating profile for the inserted type of aerosol-generating article 10. In this way power supply to the heating element 34 may be tailored to the configuration of the specific type of aerosol-generating article 10. Aerosol-generation and the user experience may thus be optimized.

In FIG. 5 various configurations of the optical detector 40 are depicted.

In the exemplary embodiment shown in FIG. 5a the optical detector comprises three light-emitting units 42A, 42B, 42C and three light-detecting units 44A, 44B, 44C. The light-emitting units 42A, 42B, 42C and three light-detecting units 44A, 44B, 44C are arranged pairwise. Thus, each light-detecting unit 44A, 44B, 44C is placed to face one of the corresponding light-emitting units 42A, 42B, 42C in a straight direction on a horizontal plane perpendicular to the longitudinal axis of the aerosol-generating device 30. The light-emitting units 42A, 42B, 42C emit light beams with the same wavelength of 520 nanometers, or over 700 nanometers. Each light-detecting unit 44A, 44B, 44C is light-sensitive enough to detect a difference in the spectrum of the emitted light beams from each of the corresponding light-emitting units 42A, 42B, 42C.

FIG. 5b shows another exemplary embodiment in which the optical detector 40 comprises three light-emitting units 42A, 42B, 42C and a single light-detecting unit 44. The light-emitting units 42A, 42B, 42C are configured to each emit light beams with a different wavelength, respectively. The light-detecting unit 44 is shaped in a long-curved semicircle strip. The light-detecting unit 44 is thereby designed to have an enlarged receiving interface and is placed to face the multitude of light-emitting units 42A, 42B, 42C on a horizontal plane perpendicular to the longitudinal axis of the aerosol-generating device 30. The light-detecting unit 44 is light-sensitive enough to detect the transmissivity of the front plug 20 with respect to each of the emitted light beams from each of the light-emitting units 42A, 42B, 42C.

1.-15. (canceled)

16. An aerosol-generating device, comprising:
a cavity configured to receive an aerosol-generating article comprising aerosol-forming substrate, and
an optical detector configured to detect a transparency of a portion of the aerosol-generating article.

17. The aerosol-generating device according to claim 16, wherein the optical detector is further configured to detect a transparency value of the portion of the aerosol-generating article.

18. The aerosol-generating device according to claim 16, wherein the optical detector comprises a light-emitting unit and a light-detecting unit.

19. The aerosol-generating device according to claim 16, further comprising a plurality of light-emitting units and/or light-detecting units.

20. The aerosol-generating device according to claim 18, wherein the light-emitting unit and the light-detecting unit are arranged on opposite sides of the cavity and face each other in a straight direction within a horizontal plane perpendicular to a longitudinal axis of the cavity of the aerosol-generating device.

21. The aerosol-generating device according to claim 20, wherein the light-emitting unit and the light-detecting unit are arranged such that light emitted from the light-emitting unit passes through a portion of an aerosol-generating article received in the cavity and the transmitted light is detected by the light-detecting unit.

22. The aerosol-generating device according to claim 16,
wherein the distal portion of the aerosol-generating article comprises a front plug, and
wherein the optical detector is further configured to detect a transparency of the front plug of the aerosol-generating article.

23. The aerosol-generating device according to claim 16,
further comprising a controller electrically coupled to the optical detector,
wherein the controller is configured to analyze an electric signal provided by the optical controller and to thereby identify the aerosol-generating article.

24. The aerosol-generating device according to claim 23,
wherein the controller comprises a memory with prestored reference data, and
wherein the controller is further configured to determine a type of the inserted aerosol-generating article by comparing a measured transparency value to the prestored reference data of the memory of the controller.

25. An aerosol-generating article, comprising:
an aerosol-forming substrate in an aerosol-forming substrate portion; and
a substrate wrapper at least partly circumscribing the aerosol-forming substrate portion,
wherein a portion of the aerosol-generating article has a predefined transparency.

26. The aerosol-generating article according to claim 25,
wherein the portion of the aerosol-generating article is formed from a front plug, and
wherein the front plug is transparent or semitransparent and has the predefined transparency.

27. The aerosol-generating article according to claim 26,
wherein the front plug comprises a transparent wrapper, and
wherein the aerosol-generating article further comprises an outer wrapper that circumscribes and connects the front plug to further components of the aerosol-generating article.

28. The aerosol-generating article according to claim 27, wherein the outer wrapper comprises a cut-out section disposed around the front plug so as to visually expose the front plug through the cut-out section in the outer wrapper.

29. An aerosol-generating system comprising the aerosol-generating device according to claim 16 and an aerosol-generating article.

30. A method for identifying an aerosol-generating article in an aerosol-generating device of an aerosol-generating system, the method comprising:
detecting, by an optical detector, a transparency of a portion of the aerosol-generating article.

31. The method according to claim 30, wherein the optical detector is configured to detect a transparency value of the portion of the aerosol-generating article.

32. The method according to claim 31, further comprising identifying the aerosol-generating article by comparing the detected optical transparency value to reference data.

33. The method according to claim 30, further comprising controlling operation of the aerosol-generating device depending upon an output of the optical detector.

34. The method according to claim 33, wherein controlling the operation of the aerosol-generating device includes deactivating operation of the aerosol-generating device if an unauthorized aerosol-generating article is detected.

35. The method according to claim 33, wherein controlling the operation of the aerosol-generating device includes choosing a heating profile of the aerosol-generating device depending upon the output of the optical detector.
